(19) United States
(12) Patent Application Publication
(10) Pub. No.: US 2020/0012801 A1
(43) Pub. Date: Jan. 9, 2020

(54) METHOD FOR SYNCHRONOUS GENERATION OF RANDOM NUMBERS FOR THE PURPOSE OF CRYPTOGRAPHIC PROCESSING

(71) Applicant: IDEMIA FRANCE, Courbevoie (FR)

(72) Inventor: Cyril PORTERET, Courbevoie (FR)

(21) Appl. No.: 16/505,140

(22) Filed: Jul. 8, 2019

(30) Foreign Application Priority Data
Jul. 9, 2018 (FR) 1856283

(51) Int. Cl. G06F 21/60; H04L 9/08; G06K 19/06

(52) U.S. Cl. CPC G06F 21/606; G06K 19/06037; H04L 9/0869

(57) ABSTRACT

The invention relates to a data transmission method between a client device (2) and a verifying device (1), comprising the following steps:
(a) simultaneous acquisition, by the verifying device and the client device, of an ambient analog signal (S),
(b) calculation, by a processor (10) of the verifying device, of a first random number obtained by applying a transformation to the ambient analog signal, and calculation, by a processor of the client device, of a second random number obtained by applying the transformation to the ambient analog signal,
(c) transmission of a first cryptographic datum, encrypted at least in part by means of an encryption function depending on the second random number, via an analog data signal, by analog signal emission means (24) of the client device (2) to analog signal acquisition means (15) of the verifying device (1),
(d) processing of the first datum by the verifying device, comprising decryption of the first datum.

### TECHNICAL FIELD OF THE INVENTION AND PRIOR ART

The present invention relates to off-line transmission of cryptographic data in a context of secure data exchange between computing devices. It applies advantageously to the authentication of a client device with a control authority.

A variety of situations necessitates a secure off-line exchange of cryptographic data between a verifying device (considered to be reliable, and potentially provided with access to confidential data) and a client device.

Several cryptographic algorithms necessitate, as a first step, the sharing by the two devices of a randomly generated datum, for example a random number generated by means of a random number generator. This is the case in particular with a large number of authentication algorithms, relying on proof of knowledge by the client device of a secret key which the verifying device possesses. “Challenge-response algorithms,” can be mentioned as examples. The verifying device communicates the random number (which constitutes the challenge) and the client device returns a datum calculated from this random number and a secret key, this datum alone not allowing the secret key to be derived. Thus, even if this datum is intercepted, it is difficult for an attacker to derive the secret key.

For the generation of the random number, it is known to include a random number generator in the verifying device. The sharing of the challenge by the verifying device with the client device necessitates that a communication channel be established between the two devices, typically via a wireless network: Internet network, 3G, 4G, NFC (“near-field communication), Bluetooth . . . Known cryptographic algorithms necessitating the sharing of a random number are therefore unusable in a context where a good network connection is not available and/or when users do not wish to use the available network. Moreover, the establishment of network communication between the client device and the verifying device can be tedious, for example if a Bluetooth connection is difficult to establish or if it is necessary to select a Bluetooth connection among a large variety of available connections. The transmission of cryptographic data via a network connection can fail or cause transmission errors, which calls into question the proper implementation of subsequent cryptographic processing. In addition, a remote attacker who intercepts communications between the verifying device and the client device can obtain the value of the random number. The security of said communications is not optimal.

### GENERAL PRESENTATION OF THE INVENTION

Thus, there exists a need for a method for transmitting data between two computing devices, in which a randomly-generated datum necessary for cryptographic processing possesses a very high level of security. There also exists a need for a data transmission method which could be used even in the absence of a network connection, while still guaranteeing the integrity of the transmitted data.

Preferably, the desired method is simple and fast.

The present invention responds to the aforementioned needs with, according to a first aspect, a method for secure off-line data transmission between a client computing device and a verifying computing device according to claim 1.

The method of the invention comprises the synchronous generation of a first random number by the verifying device and of a second random number by the client device, based on the same ambient synchronous signal acquired simultaneously by the two devices. The first random number and the second random number correspond to the same random data profiting from a very high level of security, because in order to covertly acquire the value of the random number an external attacker would have to acquire the same ambient analog signal as the verifying device and the client device.

Moreover, it is not necessary to have a network connection between the client device and the verifying device.

Another advantage is that the acquisition of the ambient analog signal can be simply accomplished by the pervasive means of mobile devices (such as a microphone, a photographic device, a movement sensor, etc.).

An additional advantage is to allow the client device to send an encrypted datum to the verifying device, without the two devices having necessarily exchanged encryption keys beforehand. Given that the encryption function used by the client device depends on the random datum obtained synchronously by the two devices, the verifying device can decrypt the datum.

The method defined above can optionally have the following features, taken alone or in any one of their technically possible combinations:
the ambient physical signal is a synchronous movement signal of the two devices,

the simultaneous acquisition of said signal being executed by means of a movement sensor of the verifying device and a movement sensor of the client device,
the verifying device and the client device are coupled during the acquisition of the synchronous movement signal, to guarantee the similarity of the signal acquired by the two movement sensors;
the two movement sensors are gyroscopes, the physical signal being representative of the variations of angular position of the two devices;
the ambient physical signal is an audible signal emitted in the environment of the two devices,

the simultaneous acquisition of said signal being executed by means of a microphone of the verifying device, and of a microphone of the client device;
the sending of the first cryptographic datum is accomplished by means of a wireless communication network, such as a mobile telephone network or an Internet network;
the analog data signal is a light signal, the analog signal possibly being a “quick response” code or “QR code,” or a steganography, or a barcode, the means of emitting the analog signal of the client device being a display screen, the second means of acquisition of the verifying device being an imaging device, preferably a photographic device.

A method of the invention having this supplementary feature is very advantageous, because the entire transmission of data can be accomplished without a network connection between the two devices, including the cryptographic processing following generation of the random number;
the verifying device and the client device are mobile devices, preferably intelligent telephones called “smartphones”;
the first cryptographic datum is a message comprising a secret encrypted by means of the encryption function;
a ciphertext of the message is generated by the verifying device and transmitted to the client device in step c), said ciphertext using an encryption key depending on the second random number;
the message is an identity document, or a payment ticket, or a text message.

The invention pertains, according to a second aspect, to a computing device comprising:

a processor,

a memory configured for recording cryptographic data,

and means of acquisition of an analog signal,

the processor being configured for:

receiving an ambient analog signal acquired by a sensor of the device, applying a transformation to the ambient analog signal received, to obtain a random number,

receiving a cryptographic datum transmitted by a second computing device, via an analog data signal transmitted to the analog signal acquisition means,

and applying a cryptographic process to said cryptographic datum.

5

A device of the invention can also have the following optional features:
the sensor is a movement sensor, for example a gyroscope, and/or a microphone;
the device also comprises a display screen and an imaging device.

Finally, according to a third aspect and a fourth aspect, the invention relates respectively to a computer program product comprising code instructions for the execution of a data transmission method as defined above, and computer-readable storage means on which code instructions for the execution of a method as defined above are previously stored.

### GENERAL PRESENTATION OF THE FIGURES

Other features, aims and advantages of the invention will be revealed by the description that follows, which is purely illustrative and not limiting, accompanied by the appended drawings among which:

FIG. 1a shows schematically a system according to a first embodiment, adapted for the implementation of a data transmission method;

FIG. 1b shows schematically a system according to a second embodiment, adapted for the implementation of a data transmission method;

FIG. 2 illustrates the steps of an exemplary data transmission method;

FIG. 3 illustrates data exchanges between a client device and a verifying device.

### DETAILED DESCRIPTION OF EMBODIMENTS

In the following, “cryptographic datum” will be understood as a datum which can be manipulated by a processor, and which is involved in a cryptographic algorithm. Cited as examples are signature, message encryption, data hashing, authentication, etc. algorithms.

Moreover, by “analog signal” is meant a continuously varying signal with corresponds to a physical phenomenon, the analog signal not being a digital signal. Typical examples of analog signals are light signals (preferably using visible light), or vibratory signals (preferably acoustic, i.e. audible signals). What is meant in particular by “ambient analog signal” is an analog signal that several computing devices can acquire at the same time in a given location, this signal being available in the environment of said devices. More precisely, the “ambient” attribute signifies that the signal is emitted into the environment of the two devices, and not by one or the other of said devices (i.e. that neither of the two is its originator). To further reformulate, the ambient analog signal is present by default in the environment, pervasively, and it will be understood that it is only acquired by said devices. Thus, the ambient analog signal is representative of a given environment and therefore the fact that both devices have available to them the same ambient analog signal makes it possible to prove that they were at the same location at the same moment.

Hereafter, similar elements in the appended drawings will be designated by the same reference symbol.

Examples of Verifier-Client Systems

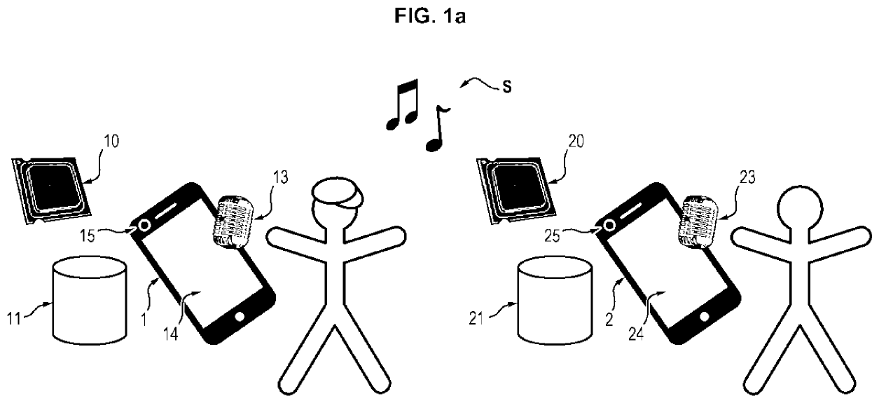

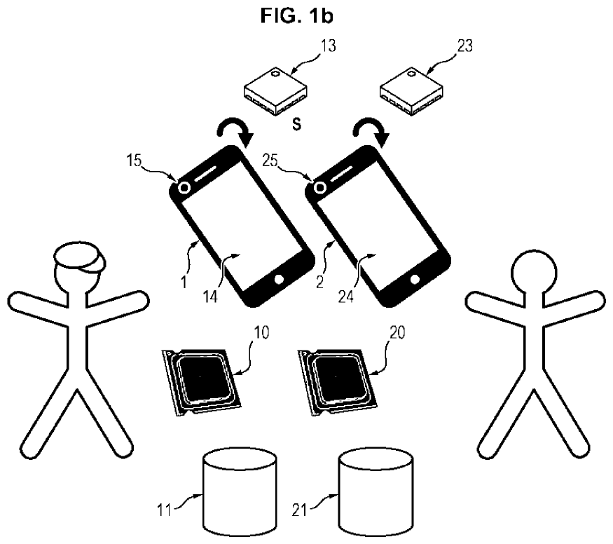

The appended FIGS. 1a and 1b correspond to two advantageous embodiments of systems adapted for the implementation of a method of the invention, comprising a verifying device 1 and a client device or even a user device, designated by the reference symbol 2.

What is meant by a “verifying device” is a device attached to a control authority. It can be a device such as a smartphone or a mobile tablet used by an individual empowered to carry out the verification, or possibly an autonomous device. Advantageously, the verifying device can have access to these data allowing verification of the identity of individuals, or allowing verification of their affiliation with a group (for example, the group of persons having purchased a ticket for participation in an event).

By “client device” is meant a device possessed by an individual who is not affiliated with a control authority, which can for example be a smartphone or a mobile tablet.

FIG. 1a illustrates schematically a first example of a system comprising a verifying device 1 and a client device 2.

The device 1 comprises data processing means 10, for example a processor, and data storage means 11, such as a random-access memory or a read-only memory.

Importantly, the device 1 comprises first means 13 for acquiring an analog signal, for acquiring an ambient analog signal as defined above. In the example of FIG. 1a, the first acquisition means correspond to a microphone which can acquire audible signals.

Optionally, the device 1 also comprises means 14 for emitting an analog signal, for emitting a “data analog signal” such as will be defined hereafter. The emitting means 14 may, or may not, correspond to the same type of analog signal as those acquired by the means 13, such as a display screen. Optionally, the device 1 comprises second means for acquiring an analog signal, for the reception of a data analog signal, such as a photographic device. The second means 15 for acquiring an analog signal can be coincident with the first acquisition means 13, or be different.

Cited as examples of alternative emission means: a luminous flash, a vibrator, an electroacoustic transducer (such as a loudspeaker), and as examples of acquisition means: a microphone, accelerometers.

It can be noted that the processor 10 is configured to apply a mathematical transformation to the ambient analog signal and possibly to save the result of the transformation. What is meant by “transformation” is meant an operation allowing a cryptographic datum to be obtained from the acquired signal, of which the result is predictable, i.e. the application of the transformation to the same signal gives, as a result, the same datum. Preferably, the transformation applied allows minimizing the impact of possible measurement noise.

The verifying device 1 can also have access to data allowing cryptographic processing to be carried out.

The device 2 comprises data processing means 20, such as a processor. The processor 20 is similar to the processor 10 as defined above; in particular, the processor 20 is configured to allow the implementation of the same transformation based on the ambient analog signals acquired. The device 2 also comprises data storage means 21, such as a random-access memory or a read-only memory. The client device 2 also comprise first means 23 for acquiring an analog signal, which are importantly configured to acquire the same type of ambient signal as the means 13 of the device 1.

Generally, the client device 2 can have all the features defined above of the verifying device 1 (except for access to confidential data allowing cryptographic processing to be carried out), and be similar to the verifying device 1.

Optionally, the client device 2 has means 24 for emitting an analog signal, such as for example a display screen, as well as second means 25 of acquiring an analog signal such as for example a photographic device.

In the exemplary method described hereafter, the means 15 and 25 for acquiring an analog signal correspond to a photographic device situated on the front face respectively of the device 1 and of the device 2, configured to take a photograph of a QR code displayed on the screens 14 and 24. The two photographic devices 15 and 25 can operate in self-portrait mode, also called “selfie mode,” so that the means 14 and 25 on the one hand, and 15 and 24 on the other hand, face each other accomplished simultaneously for an easy interactive exchange of visual signals.

Advantageously, the devices 1 and 2 are not connected via a network connection for the implementation of the method that follows. However, the devices 1 and 2 can alternatively have an Internet connection available via Wi-Fi, 3G or 4G or a mutual connection via Bluetooth.

FIG. 1b illustrates a second example of a system comprising a verifying device 1 and a client device 2.

The devices 1 and 2 can be similar to the device described above in relation to FIG. 1a, except as regards the means 13 and 23 for acquiring an analog signal which correspond to the ambient analog signal: here, devices 1 and 2 comprise, respectively as means 13 and 23, movement sensors. Advantageously, said sensors 13 and 23 are gyroscopes. The means 13 and 23 are in particular configured to acquire variations in the angular position of the two devices 1 and 2, for example variations in angular position of a plane parallel to the front face and the rear face of said devices.

It will be noted that the devices 1 and 2 could comprise both a microphone and a movement sensor as means for acquiring an ambient analog signal.

Hereafter, examples of data transmission methods, comprising synchronous generation of a random number followed by an authentication of the client device 2 with the verifying device 1, will be described in relation to the system of FIG. 1a—the ambient analog signal being an audible signal. A person skilled in the art will know, however, how to transpose the teaching of these examples for the implementation of a method of this type by the system of FIG. 1b, and more generally for the implementation of any cryptographic data transmission method which would include the prior generation of a random datum shared between two devices.

Case of a Client Authentication via a CHAP Protocol

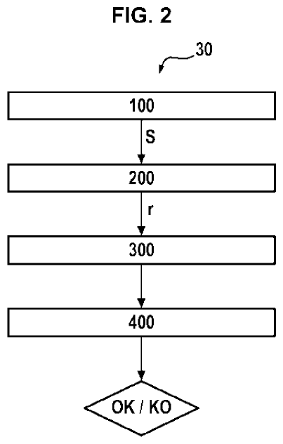

FIG. 2 represents schematically the steps of an authentication method 30 of the client device 2 with the verifying device 1. Here the authentication is carried out according to a CHAP type protocol, meaning “Challenge-Handshake Authentication Protocol.”

By way of an example, the client device can belong to an individual having previously paid and received a ticket for participation in an event (such as a concert seat). The individual uses the device 2 which he possesses to show the ticket to a guard who possesses the verifying device 1. The verifying device 1 then launches an authentication of the client device 2, to prove that the individual is an authentic ticket purchaser. The devices 1 and 2 are located in a location where the network connection is weak or nonexistent, or the user and the verifier do not wish to exchange by means of the available network connection. The principle, well known to a person skilled in the art, of a CHAP authentication protocol, which is a challenge-response type method, is the following. The verifying device 1 and the client device 2 first share a datum r, called a “nonce” (i.e. an arbitrary number, namely a single-use random number, from the expression “number used once”). The use of such an arbitrary number greatly reinforces the security of the method, because a different and random nonce value is used at each authentication, making replay attacks difficult.

Moreover, the verifying device 1 knows a private key k, and desires to verify the knowledge of it by the client device 2. In the context of participation in a concert, the private key k can be a secret element communicated to the client device 2 after finalization of the purchase.

During the CHAP protocol, the client device 2 applies a predetermined cryptographic function f to the nonce r and to the private key, then calculates a hash (also called a “cryptographic fingerprint”) from the result given by this function f. The verifying device 1, for its part, applies the same function f to the nonce and to the private key, then calculates the hash by means of the same hashing function. The authentication is considered successful if the value of the hash returned by the client device 2 and the value of the hash calculated independently by the verifying device 1 are equal.

The authentication method 30 according to the CHAP protocol comprises the following steps.

In an optional step not shown in the Figures, the client device 2 transmits a wake-up signal to the verifying device 1. This step can be omitted, for example if the verifying device 1 has initiated the authentication.

A first phase of the method 30 consists, for the devices 1 and 2, of obtaining the same value of the nonce r, the nonce r playing here the role of the random number.

A first step (a) comprises the simultaneous acquisition 100, by both devices 1 and 2, of the same ambient analog signal S. Here, the ambient analog signal S is an audible signal. This can be an audible signal available in the environment of the devices 1 and 2, in particular background noise, the devices 1 and 2 being close to one another. The audible signal S is for example treated as a signal or a series of signals having a precise frequency, this frequency being able to vary to give rise to different values of the nonce r. The signal S is acquired by the first means 13 and 23 for acquiring an analog signal of the devices 1 and 2, which are microphones here.

Alternatively, and in particular if the method 30 is implemented by the system of FIG. 1b, the ambient analog signal S can correspond to a synchronous movement of the two devices 1 and 2 together. The first means 13 and 23 for acquiring an analog signal are then movement sensors. By “synchronous movement” of the two devices 1 and 2 is meant that the absolute movement acquired by each of the two movement sensors is assumed to be substantially identical. The synchronous movement is obtained by having the devices subjected to identical mechanical forces during the movement.

For example, a synchronous movement of the devices 1 and 2 can be obtained by coupling the two devices, face to face, or side to side, during the acquisition by the movement sensors 12 and 22.

One advantage of the fact that the devices are moved together and coupled is to guarantee the simultaneity and the similarity of the signal acquired by the two movement sensors.

The method 30 continues with a second step (b) including the calculation 200 of the random number (here, the nonce r) from the ambient analog signal S acquired. During step 200, the verifying device 1 and the client device 2 calculate respectively, and independently, a first random number and a second random number which correspond substantially to the same random datum. The two devices 1 and 2 are configured to apply the same transformation T to the signal S acquired, so as to obtain the same nonce r.

For example, the processors 10 and 20 carry out the following transformation; selection of the fundamental frequency v of the audible signal S, then application to this fundamental frequency v of a mathematical application A, the value of the nonce being r=A(v).

Steps (a) and (b) taken in association have the great advantage of allowing a “sharing” of the value of the nonce r), without having the slightest communication of data between the devices 1 and 2.

A first concern is to make very difficult the interception by a third-party attacker of the value of the nonce r; a second concern is that the steps (a) and (b) can be implemented in the absence of any network connection.

The method 30 continues with a step (c) comprising the transmission of a first cryptographic datum D by the client device 2. The datum D corresponds here to the response of the client device 2 within the scope of the CHAP algorithm.

During this step (c), the client device 2 applies an arbitrary cryptographic function f accepting as input on the one hand the second random number obtained previously (the nonce r), and on the other hand the private key k. The function f has previously been shared between the devices 1 and 2. For example, the function f can be a simple addition, in which case f(r,k)=r+k. Here, the first cryptographic datum has the value D=H(f(r,k)) with H being a hashing function.

The client device 2 then accomplishes the transmission 300 to the verifying device 1 of the first cryptographic datum D calculated from the value of the second random number.

According to a first possible variant, the client device 2 transmits a message to the verifying device 1 by means of a network connection of the 3G, 4G, Bluetooth . . . type.

According to another possible variant, the cryptographic datum D is therefore communicated via a second analog signal denoted C, which is an analog data signal. This analog data signal C differs from the ambient analog signal S in that it is emitted by the client device 20.

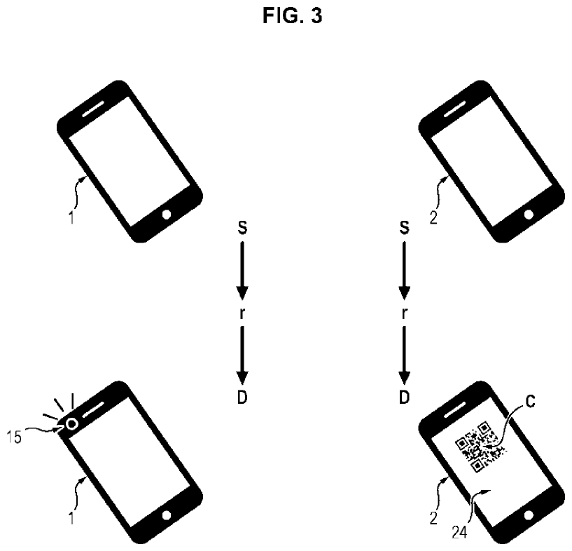

Advantageously, the analog data signal C is a visual code in the form of a QR Code representing the value H(f(r,k)). The embodiment where the first cryptographic data D is transmitted in the form of a QR Code is shown in FIG. 3, which illustrates schematically the implementation by the devices 1 and 2, (which can for example correspond to FIGS. 1a or 1b) of the method 30. Following the determination of the datum D, the client device 2 displays on its display screen 24 the QR Code C representing the datum D.

Alternatively, the signal C could be a visual code in which the value H(f(r,k)) is concealed by steganography, or a barcode such as an EAN (“Electronic Article Number”) code.

It is possible to provide a supplementary step of acquisition by the client device 2 of a verification signal transmitted by the verifying device 1, to verify the integrity of the transmission.

This second variant is advantageous, because even for communicating the datum D, the two devices do not need a network connection.

Returning to FIG. 2, the method 30 continues with a cryptographic processing step (d), here a process implemented by the verifying device 1 for the purpose of authentication. In this example, the step (d) comprises the generation of a second cryptographic datum which corresponds to the expected value of H(f(r,k)), and the verification 400 that the first cryptographic datum D transmitted in step (c) by the client device 1 and the second calculated cryptographic datum are identical. It should be noted that the generation of the second cryptographic datum could be accomplished by the verifying device 1 at any time between the calculation 200 of the value of the nonce r and the verification 400.

To take into account possible disparities between the first cryptographic datum generated by the client device 2 and the second cryptographic datum generated by the verifying device 1, the step 400 can optionally comprise a distance calculation between the first cryptographic datum and the second cryptographic datum.

The verification 400 returns as a result an “OK” or a “KO.” If the verification is positive, the client device 2 is considered here to be authenticated. As an alternative, subsequent cryptographic processing can occur to terminate the authentication.

In this example, if the verification is positive, the individual who possesses the device 2 has proven that he has acquired in a regular manner an electronic concert ticket, because he had in his possession the private key k. The authentication of the individual who possesses the client device 2 is therefore terminated, and the individual is allowed to enter the concert hall.

Case of Transmission of a Message by the Client Device

According to an alternative embodiment of the method 30, the client device 2 transmits an encrypted message M to the verifying device 1, after synchronous generation of a random number by the verifier 1 and the client 2.

Advantageously, the message M is an identity document of an individual who possesses the client device 2. Alternatively, the message M can be a payment ticket, a text message or generally any numerical content which can be transmitted by the client device 2 to the verifying device 1.

The random number obtained by synchronous generation by the two devices, in conformity with step (a) described above in relation to FIG. 2, can be used to obtain an encryption key or several encryption keys, for example a private key k and a public key Cp in the case of asymmetric encryption.

Thus, in the case of asymmetric encryption, the client device 2 is then able to use the private key to generate a ciphertext of the message M by means of an encryption function Ch. The ciphertext Ch(M) depends for example on the private key k, itself obtained based on the second random number obtained by the client 2 after the synchronous generation of a random number, and depends on a hash H(M) of the message M.

The verifying device is then able to decrypt the ciphertext Ch, by means of the public key Cp.

Said ciphertext comprises for example a signature of the message M.

One advantage is that the verifier 1 and the client 2, who have not necessarily previously exchanged cryptographic keys, are able to communicate to one another an encrypted message quickly and securely. The use of an analog data signal for the transmission of the ciphertext of the message by the client device 2 to the verifying device 1, reinforces the security of the data exchange with respect to potential attacks.

In the case of symmetric encryption, the client device 2 is then able to use the encryption key to generate a ciphertext of the message M, by means of a symmetric encryption function ChS. The ciphertext ChS(M) depends on the encryption key, itself obtained based on the second random number obtained by the client 2 after the synchronous generation of a random number, and depends on a hash H(M) of the message M.

The verifying device is then able to decipher the ciphertext ChS, by means of the encryption key. There too, the verifier 1 and the client 2 can exchange a message in a secure manner without a prior exchange of cryptographic keys being necessary, and, if necessary, without a network connection between the two devices 1 and 2.

In the case of a digital signature of the message M, for example a signature of the DSA, for “Digital Signature Algorithm” type, cryptographic processes allow not only authenticating the client device 2, but also proving the integrity of the message M.

In known fashion, the calculation of a DSA message signature uses a public key (p,q,g,y) and a private key k.

Recall that a method for generating a public key and a private key according to the DSA algorithm comprises the following steps:
Selecting a prime number of length L such that 512≤L≤1024, and L is divisible by 64;
Select a prime number q of 160 bits, in such a manner that p−1=q*c, with c an integer;
Select h, with 1<h<p−1 so as to construct g such that g=h\hat{ }c mod p>1;
Generate randomly a number k, with 0<k<q;
Calculate y=g\hat{ }k mod p.

According to one example the DSA signature of a message M by the client device 2, here the signature of the identity document, begins with a “hash” calculation H(M) by means of a hashing function such as SHA256, then continues with the calculation of two values s₁ and s₂ such that:

s₁=(g\hat{ }r mod p) mod q;

s₂=(H(M)+s1*k)*r\hat{ }(−1) mod q,

where r is a nonce which must be drawn arbitrarily for each DSA signature. The nonce guarantees that, even in the case of a replay attack, the intercepted data will not be re-usable for fraudulent authentication.

Within the scope of this example, the transmission of the message M by the client device 2 and its processing by the verifying device 1 are accomplished according to steps (a) to (d) similar to the steps described above in relation to the CHAP protocol, with the same possible variants:
During step (a), the verifying device 1 and the client device 2 acquire the same ambient analog signal S;
During step (b), the verifying device 1 and the client device 2 apply the same transformation T to the signal S acquired, so as to obtain respectively a first random number and a second random number;
During step (c), the device 2 accomplishes the calculation of a first cryptographic datum D, which corresponds in the case of a DSA signature to the pair (s₁, s₂) as defined above, then transmits said datum at the same time as the message M, for example an image of an identity document.

The signature of the message M, more particularly the portion s₂ of this signature, depends on the second random number acquired by the client device 2 during the synchronous generation of the random number, as well as the hash H(M) of the message.

The transmission of the cryptographic datum D can advantageously be accomplished in an “off-line” manner by means of an analog data signal C, as described above. Advantageously, the message M is then also transmitted via this same signal or another analog data signal.

The transmission of the analog data signal C can in particular be carried out by the analog signal emission means 24 of the client device 2 and for the analog signal acquisition means 15 of the verifying device 1.
During step (d), the verifying device 1 accomplishes the verification of the integrity of the identity document, and optionally the authentication of the client device 2. If the two verifications are positive, the client device is considered to be validly authenticated.

1. A method for off-line secure data transmission between a client computing device (2) and a verifying computing device (1), the method comprising the following steps:
a) simultaneous acquisition (100) by the verifying device (1) and the client device (2) of an ambient analog signal (S),
b) calculation (200), by a processor (10) of the verifying device (1), of a first random number obtained by applying a transformation to the ambient analog signal (S) and calculation, by a processor (2) of the client device (2), of a second random number obtained by applying the transformation to the ambient analog signal (S),
c) transmission (300) by the client device (2), to the verifying device (1), of a first cryptographic datum (D) encrypted at least in part by means of an encryption function depending on the second random number, said transmission being carried out via an analog data signal (C) by analog signal emission means (24) of the client device (2) to analog signal acquisition means (15) of the verifying device (1),
d) processing of the first cryptographic datum (D) by the verifying device (1), said processing comprising decryption of the first cryptographic datum (D).

2. The method according to claim 1, wherein the ambient analog signal (S) is a synchronous movement signal of the two devices (1, 2), the simultaneous acquisition (100) of said signal being executed by means of a movement sensor (13) of the verifying device (1) and of a movement sensor (23) of the client device (2),
the verifying device (1) and the client device being coupled during the acquisition (100) of the synchronous movement signal, to guarantee the similarity of the signal acquired by the two movement sensors (12, 22).

3. The method according to claim 2, wherein the two movement sensors (13, 23) are gyroscopes, the ambient analog signal (S) being representative of variations in angular position of the two devices (1, 2).

4. The method according to claim 1, wherein the ambient physical signal (S) is an audible signal emitted in the environment of the two devices (1, 2),
the simultaneous acquisition (100) of said signal being executed by means of a microphone of the verifying device (1) and of a microphone by the client device (2).

5. The method according to claim 1, wherein the verifying device (1) and the client device (2) are mobile devices, preferably smartphones.

6. The method according to claim 1, wherein the analog data signal (C) is a luminous signal, for example a “Quick Response” code or “QR Code,” or a steganography, or a barcode,
The analog signal emission means (24) of the client device being a display screen,
the second analog signal acquisition means (15) of the verifying device (1) being an imaging device, preferably a photographic device.

7. The method according to claim 1, wherein the first cryptographic datum (D) is a message (M) comprising a secret encrypted by means of an encryption function.

8. The method according to claim 7, wherein a ciphertext of the message (M) is generated by the verifying device (1) and transmitted to the client device (2) in step c), said ciphertext using an encryption key depending on the second random number.

9. A computing device (1) comprising:
a processor (10),
a memory (11) configured for recording cryptographic data (k),
analog signal acquisition means (15),
wherein the processor is configured for:
receiving an ambient analog signal (S) acquired by a sensor of the device (1),
applying a transformation to the received ambient analog signal, to obtain a random number (r),
receiving a cryptographic datum (D) transmitted by a second computing device (2), via an analog data signal (C) transmitted to the analog signal acquisition means (15),
and applying a cryptographic process to said cryptographic datum (D).

10. The device according to claim 9, wherein the sensor is a movement sensor, preferably a gyroscope, and/or comprising a microphone as a sensor.

11. The device according to one of claim 9 or 10, also comprising a display screen (14) and an imaging device (15).

12. A computer program product, comprising code instructions for the implementation of a data transmission method according to claim 1 when said code instructions are executed by a processor.

13. Computer-readable storage means on which are pre-recorded code instructions for the implementation of a data transmission method according to claim 1.
